(19) United States
(12) Patent Application Publication
(10) Pub. No.: US 2014/0376043 A1
(43) Pub. Date: Dec. 25, 2014

(54) JOB PROCESSING APPARATUS, DISPLAY CONTROL METHOD OF JOB PROCESSING APPARATUS, AND STORAGE MEDIUM

(71) Applicant: CANON KABUSHIKI KAISHA, Tokyo (JP)

(72) Inventor: Kosuke Tsujita, Tama-shi (JP)

(21) Appl. No.: 14/299,614

(22) Filed: Jun. 9, 2014

(30) Foreign Application Priority Data
Jun. 24, 2013 (JP) 2013-131636

(51) Int. Cl. G06K 15/02

(52) U.S. Cl. CPC G06K 15/1809
USPC 358/1.15

(57) ABSTRACT

Displayed jobs are combined by a simple operation instruction to a schedule screen of jobs which are displayed. A job processing apparatus has: a display unit for displaying a schedule screen of jobs to be executed; a receiving unit for receiving an operation for moving a display object of a first job displayed on the schedule screen to a display object of a second job; and a combining unit for combining the first and second jobs in accordance with the received operation.

### BACKGROUND OF THE INVENTION

1. Field of the Invention

The present invention relates to a job processing apparatus, a display control method of the job processing apparatus, and a storage medium.

2. Description of the Related Art

In a production market, ordinarily, a dedicated operator is allocated to a print system. The operator decides inputting order of a print job, inputs the print job into the print system, performs a paper feed to execute the print job, and manages a print progress situation. The operator also changes a print setting of the input print job in accordance with necessity.

It is required that the operator executes the printing while reducing a down-time of the print system as much as possible. To support it, a function to display a print situation onto a screen is provided for the print system. (Refer to the Official Gazette of Japanese Patent Application Laid-Open No. 2004-348713.) A print job which is being executed and print jobs which are scheduled to be executed are displayed on a screen by a time base. The operator can grasp a print progress situation by watching the display screen (hereinbelow, referred to as a schedule screen).

A function to combine a plurality of print jobs is provided for the print system. For example, when the plurality of print jobs input to the print system are combined, the operator operates the schedule screen, thereby allowing a print job list screen to be displayed on the screen. On the displayed print job list screen, by selecting print jobs to be combined and depressing a Combine button, the plurality of print jobs can be combined.

In order to combine two print jobs displayed on the schedule screen, the following operation is necessary. First, jobs which are displayed on the schedule screen have been stored in a queue called “schedule queue”. The print system does not presume combining of the print jobs stored in the schedule queue.

The print job combination is performed only to the print jobs held in a queue called “waiting queue” which manages the print jobs to which a print execution is not instructed yet. Therefore, when a print combination is performed, the operator operates the schedule screen, thereby allowing the print job list screen of the print jobs which are input to the schedule queue to be displayed. The operator selects the print jobs to be combined and moves the print jobs to the waiting queue. The operator shifts the screen to the print job list screen to display a list of the print jobs which are stored into the waiting queue, selects the print jobs to be combined, and depresses the Combine button. Further, the operator selects the combined print job and instructs the printing, thereby moving to the schedule queue. In this manner, a flow for a process to combine the print jobs stored in the schedule queue is executed. The operator needs to grasp the progress situation of the print jobs while always watching the schedule screen. If the combining operation is executed by the foregoing procedure in such a situation, it takes a time, the operator cannot continuously grasp the print situation, and the printing operation is interfered.

### SUMMARY OF THE INVENTION

According to an aspect of the invention, there is provided a job processing apparatus comprising: a display unit configured to display a schedule screen of jobs to be executed; a receiving unit configured to receive an operation for moving a display object of a first job displayed on the schedule screen to a display object of a second job; and a combining unit configured to combine the first job and the second job in accordance with the operation received by the receiving unit.

Further features of the present invention will become apparent from the following description of exemplary embodiments with reference to the attached drawings.

### BRIEF DESCRIPTION OF THE DRAWINGS

FIG. 1 is a block diagram illustrating a construction of a job processing apparatus.

FIG. 2 is a block diagram for describing a construction of modules of the job processing apparatus.

FIGS. 3A and 3B are diagrams illustrating UI screens which are displayed on an operation panel.

FIGS. 4A and 4B are diagrams illustrating schedule management tables.

FIG. 5, which is composed of FIGS. 5A and 5B, is a flowchart for describing a control method of the job processing apparatus.

FIG. 6 is a diagram illustrating a UI screen which is displayed on the operation panel.

FIGS. 7A and 7B are diagrams illustrating UI screens which are displayed on the operation panel.

FIG. 8 is a flowchart for describing the control method of the job processing apparatus.

FIGS. 9A and 9B are diagrams illustrating UI screens which are displayed on the operation panel.

FIGS. 10A and 10B are diagrams illustrating waiting job management tables.

FIG. 11 is a diagram illustrating a UI screen which is displayed on the operation panel.

FIG. 12 is a diagram illustrating a UI screen which is displayed on the operation panel.

FIGS. 13A and 13B are diagrams illustrating waiting job management tables.

FIG. 14 is a diagram illustrating a schedule management table.

FIG. 15 is a diagram illustrating a UI screen which is displayed on the operation panel.

FIG. 16 is a flowchart for describing a control method of the job processing apparatus.

FIG. 17 is a diagram illustrating a UI screen which is displayed on the operation panel.

FIGS. 18A and 18B are diagrams illustrating waiting job management tables.

FIG. 19 is a diagram illustrating a schedule management table.

FIG. 20 is a diagram illustrating a UI screen which is displayed on the operation panel.

### DESCRIPTION OF THE EMBODIMENTS

Subsequently, best modes for embodying the invention will be described with reference to the drawings.

### Description of System Construction

### First Embodiment

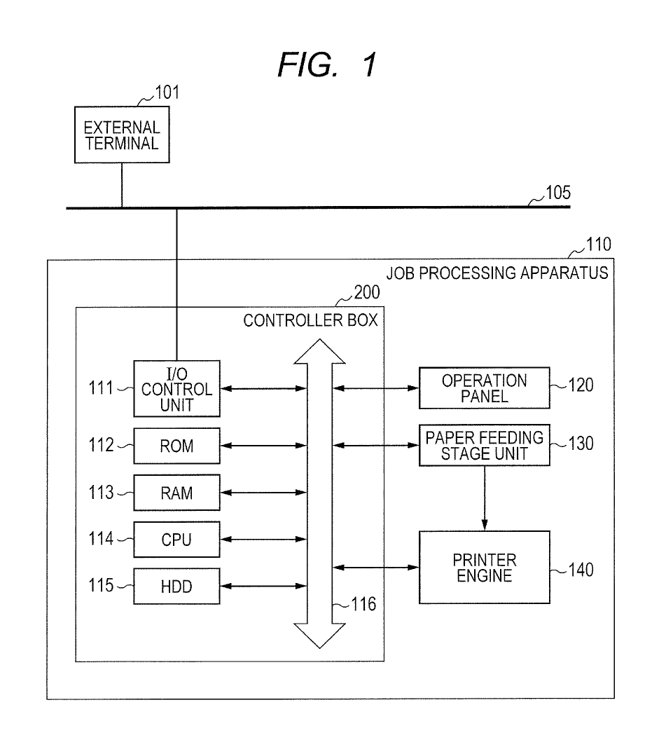

FIG. 1 is a block diagram illustrating a construction of a job processing apparatus showing an embodiment. This diagram illustrates an example in which an external terminal 101 and a job processing apparatus 110 can communicate through a communication line 105. Naturally, a plurality of external terminals may be connected to the external terminal and a number of users can use their own computers as external terminals.

In FIG. 1, the external terminal 101 acquires input information which is input by an input device (not shown) from the user, generates a print job which is transmitted to the job processing apparatus 110, and transmits to the job processing apparatus 110 through the communication line 105. A controller box 200 executes various kinds of data processes and controls the operation of the job processing apparatus 110.

An operation panel 120 receives various kinds of operations from the user through a UI such as a touch panel or the like. A paper feeding stage unit 130 is a paper feeding stage constructed by a plurality of paper feeding stages. Print paper can be stored in each paper feeding stage. Upon printing, the print paper is conveyed to a printer engine 140. The printer engine 140 prints an image onto the print paper on the basis of image data and outputs.

Subsequently, a construction of the controller box 200 will be described. An I/O control unit 111 controls a communication with an external network.

A ROM 112 stores various kinds of control programs. The control programs stored in the ROM 112 are read out and stored in a RAM 113. A CPU 114 executes the control programs stored in the RAM 113 and integratedly controls an image signal and various kinds of devices. An HDD 115 is used to temporarily store data of a large capacity such as image data, print data, and the like or to store them for a long period of time.

The devices are mutually connected through a system bus 116. Further, the system bus 116 mutually connects the controller box 200 and each device in the job processing apparatus 110. The RAM 113 also functions as a main memory or a work memory of the CPU 114. The control programs and an operation system are stored in not only the ROM 112 but also the HDD 115. Further, the apparatus may have an NVRAM (not shown) and store print apparatus mode setting information which is input from the operation panel 120. A schedule screen, which will be described hereinafter, is properly displayed on the operation panel 120.

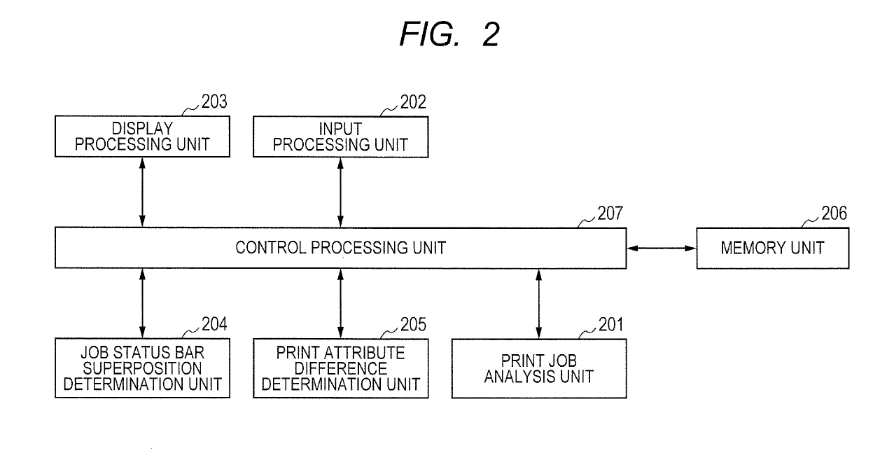

FIG. 2 is a block diagram for describing a construction of modules of the job processing apparatus 110 illustrated in FIG. 1. The CPU 114 executes each module, thereby executing a corresponding data process. A memory unit 206 corresponds to the RAM 113 serving as hardware illustrated in FIG. 1 and stores data which is used in a module, which will be described hereinafter.

In FIG. 2, a print job analysis unit 201 analyzes various kinds of print jobs received by the job processing apparatus 110 such as a print job transmitted from the external terminal 101 and the like and reads out print setting information included in the print job. The print setting information mentioned here mainly denotes information regarding a size of paper used for printing, a paper kind, a paper feeding stage, a finishing setting, and the like.

The print setting which was read out by the print job analysis unit 201 is temporarily stored in a storage device such as RAM 113, HDD 115, or the like. An input processing unit 202 receives various kinds of inputs acquired when the operator operates the operation panel. A display processing unit 203 displays a print schedule.

A job status bar superposition determination unit 204 discriminates whether or not a print job combining instruction has been made by the operator's operation. A print attribute difference determination unit 205 discriminates whether or not there is a difference among attributes of a plurality of print jobs to which a print job combining instruction has been made by the user's operation. The memory unit 206 stores data to be processed by the job status bar superposition determination unit 204 and the print attribute difference determination unit 205 and screen data to display the schedule screen, which will be described hereinafter. A control processing unit 207 has a function for processing control of the functions of the units 201 to 206 on the basis of the foregoing programs.

### With Respect to Display Contents on Schedule Screen

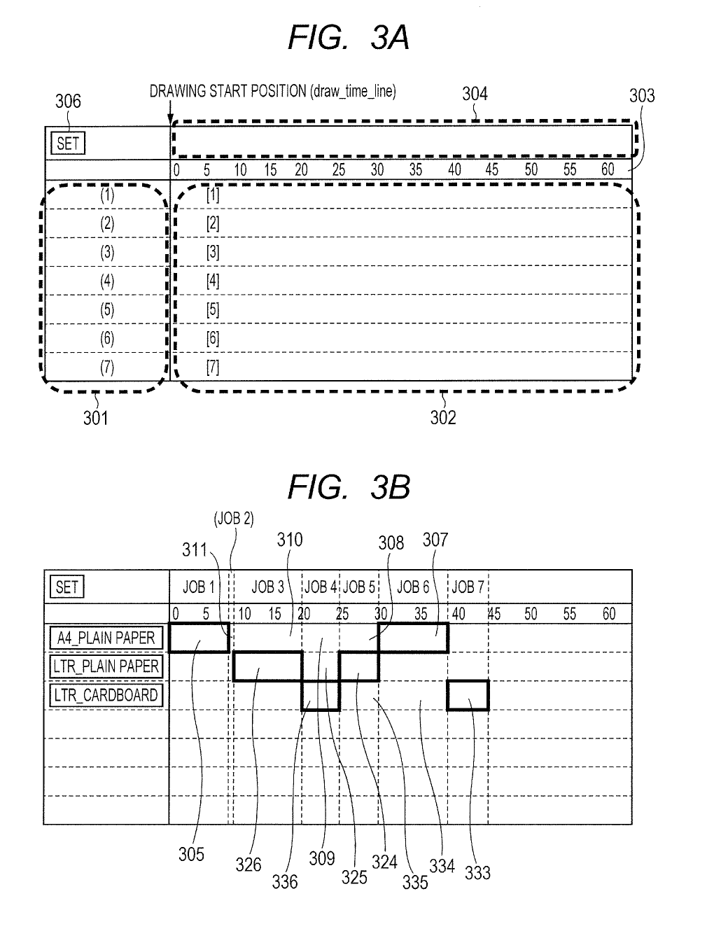

FIGS. 3A and 3B are diagrams illustrating user interface screens (UI screens) which are displayed on the operation panel 120 illustrated in FIG. 1. This example corresponds to the schedule screen which is displayed by a display apparatus. In the embodiment, a description will be made hereinbelow with respect to an example in which a job combining process is executed by receiving such an operation that the operator drags & drops a display position of a bar of a job schedule displayed on the schedule screen. In this case, a bar which is dragged first is referred to as “moving source” and a bar which is dropped is referred to as “movement destination”.

FIG. 3A illustrates a construction of each area which is displayed on the schedule screen displayed on the operation panel 120. This screen has been stored in the memory unit 206. The display processing unit 203 displays the schedule screen onto the operation panel 120 in response to an instruction from the control processing unit 207. The operator can grasp the progress situation of the print jobs by watching the schedule screen.

A call button (“SET” button) 306 is depressed when calling a setting screen regarding a screen enlargement process, which will be described hereinafter. The screen enlargement process will be described in detail hereinafter. A kind of paper to be used by the print job is displayed in a display area 301. A print job name is displayed in a display area 304. A time base 303 is shown when a drawing start position is set to current time. Starting time and a necessary time of each print job are drawn as a job status bar into a display area 302.

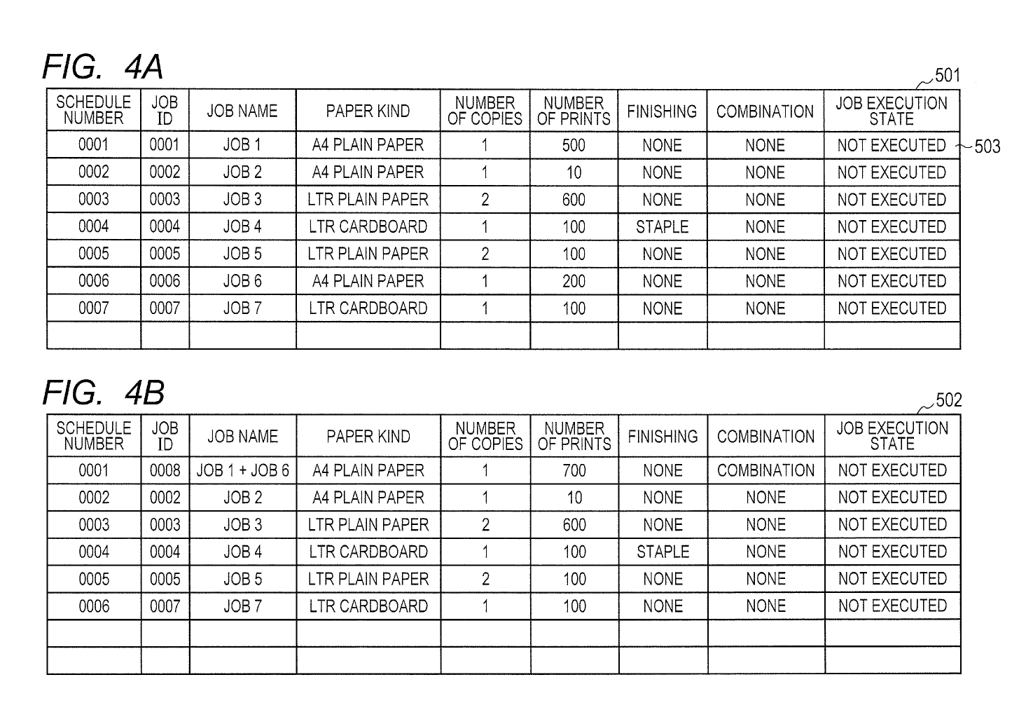

The print jobs analyzed by the print job analysis unit 201 are stored into a schedule queue provided in the RAM 113. Images in which the print jobs are stored in the schedule queue are illustrated in FIGS. 4A and 4B. The print jobs which are input to the schedule queue are managed by a schedule management table 501 provided in the RAM 113. For example, as shown in the schedule management table 501 illustrated in FIG. 4A, it is now assumed that seven kinds of print jobs have been stored in correspondence to schedule numbers 0001 to 0007.

At this time, the control processing unit 207 accesses the schedule management table 501 and reads out the print job of schedule No. 0001. A time which is required to print is calculated on the basis of the paper kind, the number of prints, and the finishing setting. After the time required to print was calculated, the paper kind name of the paper which is used by the print job is drawn in a display area 301-(1).

Further, on the basis of the calculated necessary time, the job status bar is drawn in a portion of a display area 302-[1] illustrated in FIG. 3A. Moreover, a job name of the print job is drawn in the display area 304. Subsequently, coordinates of the position where the job status bar has been drawn are stored into the RAM 113. The drawing position is shifted to the right by a distance corresponding to a print necessary time. In this manner, the drawing process of the job status bar is executed to all print jobs registered in the schedule management table.

FIG. 3B illustrates a schedule screen in which all of the print jobs shown in the schedule management table 501 were drawn. An updating of the schedule management table, a drawing process of the schedule screen, and an updating of the drawing position coordinates are periodically executed even during the print process. When the print process progresses, the number of prints during the print progress is decreased and a size of the job status bar which is drawn is also updated in accordance with it so that its width is narrowed. Since a drawing method and drawing contents of the schedule screen are a well-known technique, a further detailed description of them is omitted here.

### Operator's Operation Area Enlargement and Print Job Combining Process by Drag & Drop

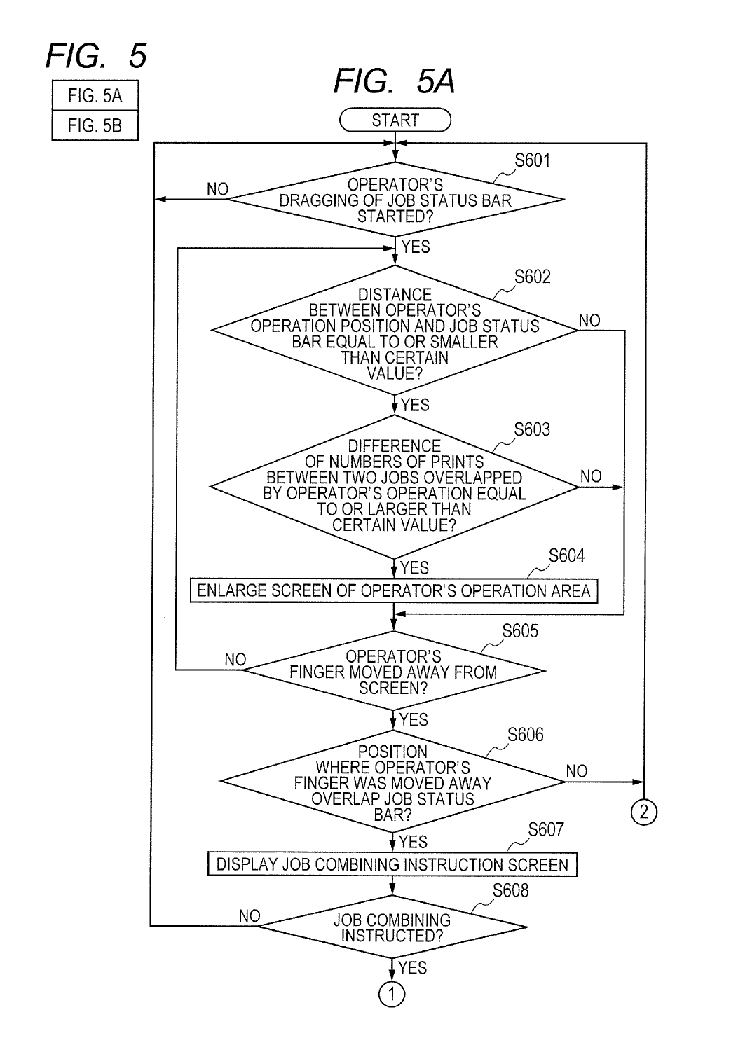

FIGS. 5A and 5B are a set of flowcharts for describing a control method of the job processing apparatus showing the embodiment. This flowchart relates to an example of the operator's operation area enlargement and print job combining process by the drag & drop operation on the schedule screen illustrated in FIG. 3B. Each processing step is realized by a method whereby the CPU 114 of the controller box 200 executes each process in accordance with the program stored in the HDD 115.

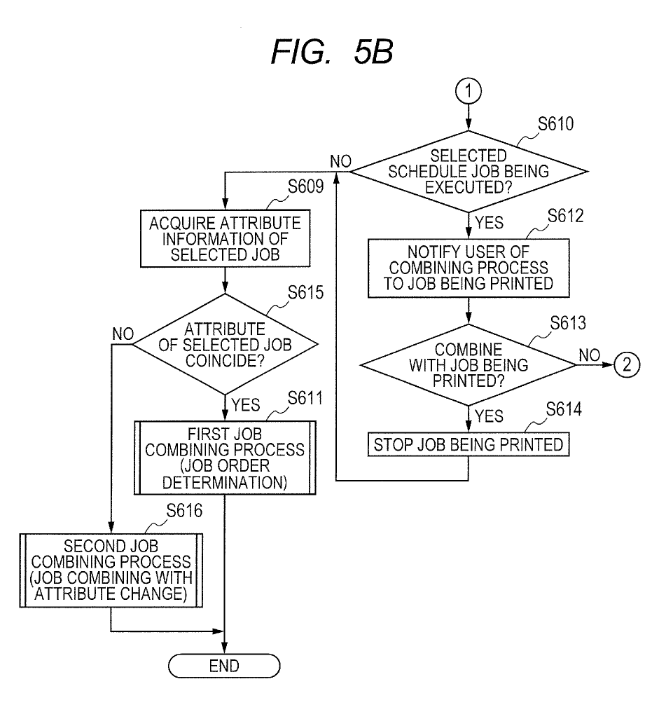

When the operator operates the operation panel 120 and depresses the “SET” button 306 on the schedule screen, the control processing unit 207 instructs the display processing unit 203 so as to display a screen enlargement process setting screen 901 illustrated in FIG. 6 onto the operation panel 120.

In the embodiment, the job status bars are combined by the operator's drag & drop. When the operator selects the print jobs to be combined, there is a case where the job status bar is displayed as an extremely short bar in dependence on a scale of the schedule screen. It is difficult for the operator to select the targets to be combined.

In order to avoid such a situation, if it is determined that a difference between the number of prints of the print job serving as a combining source and the number of print jobs of the job status bar which is closer to the operator's screen dragging operation is equal to or larger than a certain value, an area near the operator's operation is enlarged. By this method, the print jobs which the operator wants to combine can be certainly selected. The screen enlargement process setting screen 901 is a display screen for making a setting regarding such an enlarging operation.

In FIG. 6, buttons 903 and 904 to determine whether or not the area near the operator's operation is enlarged when approaching the job status bar of the large difference in number of prints by the operator's dragging operation are provided for a setting section 902. A setting section 905 has a print number setting section 906 to determine whether or not the area near the operator's operation is enlarged when the difference between the number of prints of the print job of the combining source and the number of prints of the print job of the approached job status bar is equal to or larger than which value (in the example illustrated in FIG. 6, “100”). When the operator operates the operation panel 120, selects the button 903, inputs “100” into the print number setting section 906, and depresses an OK button 907, the control processing unit 207 writes such a value into the RAM 113.

With respect to whether or not the area near the operator's operation is enlarged when the job status bar has approached by which extent, it may be enlarged when the position which is instructed while the operator is dragging the operation panel 120 overlaps the position of the center of gravity of the job status bar. It may be also enlarged when the position overlaps any place in the area of the job status bar. In the embodiment, the process for enlarging the area near the operator's operation is executed when the position which is instructed while the operator is dragging the operation panel 120 overlaps the position of the center of gravity of the job status bar.

As an initial state, the print jobs which were input to the schedule queue are seven print jobs which are managed by the schedule management table 501 illustrated in FIG. 4A. It is assumed that on the basis of them, the schedule screen illustrated in FIG. 3B has been displayed on the operation panel 120.

It is also assumed that “100” was input to the print number setting section 906 on the screen enlargement process setting screen 901 by the operator. When the operator depresses a display screen 307 for displaying the job status bar on the operation panel 120 in order to combine JOB 6 to JOB 1, in S601, the input processing unit 202 notifies the control processing unit 207 of it. The control processing unit 207 determines that the drag of the job status bar by the operator has been started, stores JOB 6 as a print job of the job status bar to which the dragging operation was started into the RAM 113, and advances the process to S602.

In S602, the control processing unit 207 acquires position coordinates of the operator's operation from the input processing unit 202, further, accesses the RAM 113, and acquires position coordinates of the job status bar.

Further, the control processing unit 207 instructs the job status bar superposition determination unit 204 so as to discriminate whether or not the position of the operator's operation overlaps the position of the center of gravity of each job status bar. The discrimination about the overlap is substantially the same as a discrimination about whether or not a distance between the operator's operation position and the job status bar is equal to or smaller than a certain value.

In order to combine JOB 6 to JOB 1, the operator sequentially drags the operation panel 120 in order of display areas 307, 308, 309, 310, and 311. For this period of time, the job status bar superposition determination unit 204 discriminates whether or not the coordinates of the operator's operation position overlap the position of the center of gravity of the job status bar. If the job status bar superposition determination unit 204 determines that the operator's operation position does not overlap the position of the center of gravity of the job status bar, the processing routine advances to S605. Processes in S603 and S604 will be described hereinafter.

In S605, the control processing unit 207 instructs the input processing unit 202 to discriminate whether or not the operator has removed the finger away from the operation panel 120. If the control processing unit 207 determines that the operator does not remove the finger away from the operation panel 120, the processing routine advances to S602. When the operator's operation position reaches the display area 311, the control processing unit 207 determines that the position of the center of gravity of the job status bar of JOB 2 overlaps the operator's operation position, and advances the process to S603. In S603, the control processing unit 207 accesses the RAM 113, acquires the numbers of prints of JOB 6 and JOB 2, and discriminates the difference of the numbers of prints about whether or not the number of output prints of the jobs to be combined is equal to or larger than a certain value.

Further, the control processing unit 207 acquires the information of the difference of the numbers of prints between the print jobs at the time of executing the enlargement process. In the case of the present time, the difference of the numbers of prints between JOB 6 and JOB 2 is equal to 190 and exceeds the difference (=100) of the numbers of prints between the jobs at the time of executing the preset enlargement process. Therefore, the control processing unit 207 advances the process to S604. In S604, the control processing unit 207 instructs the display processing unit 203 so as to enlarge the screen near the coordinates of the operator's operation position.

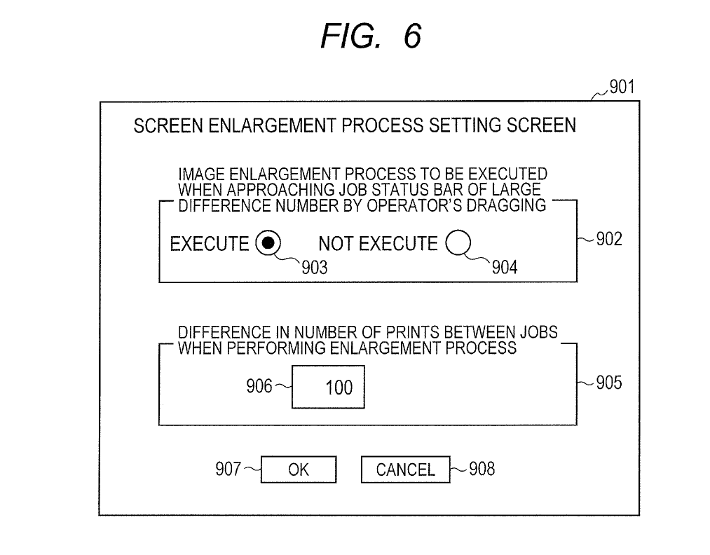

By such an instruction, the display processing unit 203 displays the screen obtained by enlarging the screen near the coordinates of the operator's operation position onto the operation panel 120 as a schedule screen 312 of FIG. 7A. Specifically speaking, for a period of time during which the movement of the area exceeding the difference of the numbers of prints is instructed, the display control for enlarging and displaying such an area is made. After the enlargement was instructed as mentioned above, the control processing unit 207 advances the process to S605. After that, when the operator moves the dragging position from the display area 311 to the display area 305, the processing routine advances to S605 and S602. When it is determined that the operator's operation position overlaps the status bar of JOB 1, the processing routine advances to S603, S604, and S605.

Although the area near the coordinates of the operator's operation position is enlarged in S604, since the screen enlargement process has already been described, its detailed description is omitted here.

At the position of a display area 305, when the operator removes the finger away from the operation panel 120, the control processing unit 207 instructs the input processing unit 202 so as to acquire the coordinates of the position where the operator removed the finger.

The control processing unit 207 discriminates in S606 whether or not the acquired position coordinates overlap the position of the center of gravity of the job status bar. If the control processing unit 207 determines that the acquired position coordinates do not overlap the position of the center of gravity of the job status bar, S601 follows.

If the control processing unit 207 determines that the acquired position coordinates overlap the position of the center of gravity of the job status bar, S607 follows. In S607, the control processing unit 207 accesses the RAM 113.

The control processing unit 207 acquires print information of the print job JOB 6 designated as a combining source when the operator starts the drag of the operation panel 120 and print information of the print job JOB 1 designated as a combination destination when the operator removes the finger away from the operation panel 120. The control processing unit 207 instructs the display processing unit 203 so as to display a screen 313, onto the operation panel 120, for selecting a combining instruction shown as an example in FIG. 7B for allowing the operator to select whether or not the print jobs are combined.

When the operator depresses a cancel button 315 in the screen 313, the control processing unit 207 writes information showing that the cancel button 315 was depressed into the RAM 113, then S608 follows. When the operator depresses an OK button 314, the control processing unit 207 writes information showing that the OK button 314 was depressed into the RAM 113, then S608 follows.

In S608, the control processing unit 207 accesses the RAM 113 and acquires a kind of button depressed by the operator in S607. If the control processing unit 207 determines that the button depressed by the operator in S607 is the cancel button 315, S601 follows. If the control processing unit 207 determines that the button depressed by the operator in S607 is the OK button 314, S610 follows.

In S610, the control processing unit 207 accesses the RAM 113 and discriminates whether or not the combining source print job JOB 6 and the combination destination print job JOB 1 are being executed (being printed). If the control processing unit 207 determines that both of those jobs are not being printed, S609 follows. In S609, the control processing unit 207 accesses the RAM 113 and acquires print attributes of the combining source print job JOB 6 and the combination destination print job JOB 1. The print attributes indicate the paper kind, the number of copies, and the finishing setting.

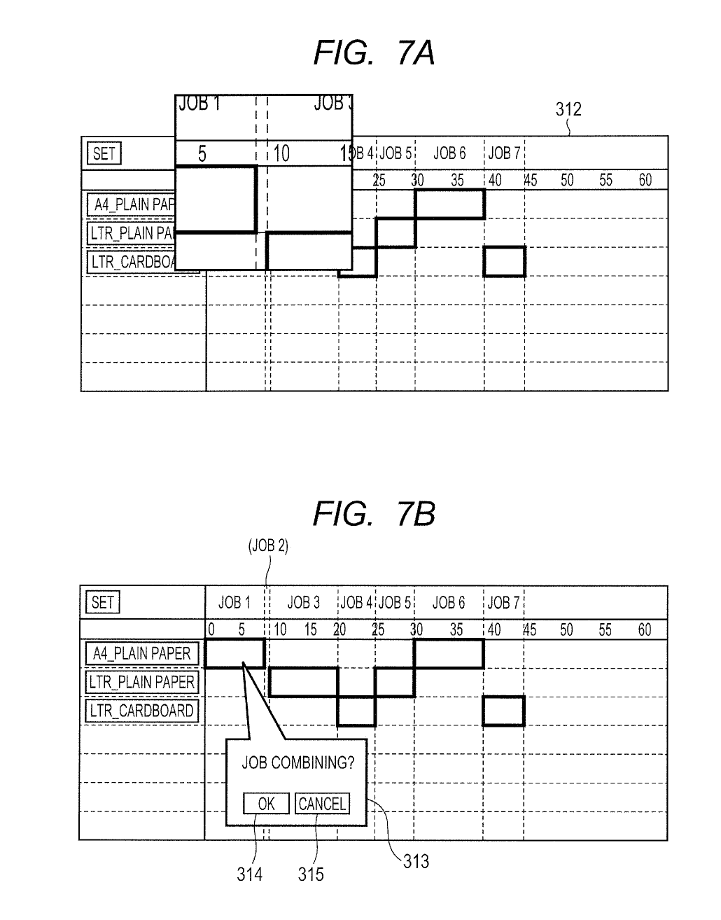

After the control processing unit 207 acquired the print attributes, S615 follows. In S615, the control processing unit 207 instructs the print attribute difference determination unit 205 so as to discriminate whether or not the print attributes acquired in S609 coincide. Since all of the print attributes of JOB 6 and JOB 1 coincide, S611 follows. Details of S611 are illustrated in FIG. 8. A process in S616 will be described hereinafter.

FIG. 8 is a flowchart for describing the control method of the job processing apparatus showing the embodiment. This flowchart relates to an example of a detailed process of the first job combining process shown at S611 in FIG. 5B. Each processing step is realized by a method whereby the CPU 114 in the controller box 200 executes each process in accordance with the program stored in the HDD 115.

In S701, the control processing unit 207 accesses the RAM 113 and discriminates whether or not the numbers of prints of JOB 6 and JOB 1 are equal to or larger than 2.

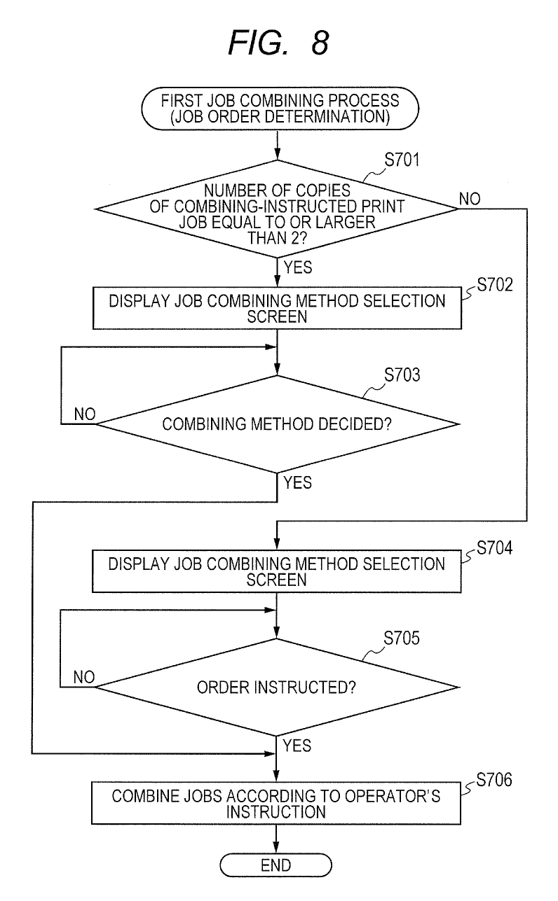

In the embodiment, since the numbers of prints of JOB 6 and JOB 1 are equal to 1, the control processing unit 207 advances the process to S704. In S704, the control processing unit 207 accesses the RAM 113 and acquires names of the print jobs of JOB 6 and JOB 1. After the job names were acquired, the control processing unit 207 instructs the display processing unit 203 so as to display a screen for selecting the combining order onto the operation panel 120. Specifically speaking, as a screen for selecting the combining order of JOB 6 and JOB 1, the screen 316 of FIG. 9A is displayed onto the operation panel 120. FIG. 9B corresponds to a display of the job schedule after the jobs were combined.

After that, the control processing unit 207 advances the process to S705. After that, the operator operates the operation panel 120 and inputs the combining order into input sections 317 and 318. When the OK button 314 is depressed, in S705, the control processing unit 207 instructs the input processing unit 202 so as to acquire the combining order which was input, accesses the RAM 113, and stores the combining order. After that, the control processing unit 207 advances the process to S706.

In S706, the control processing unit 207 accesses the RAM 113 so as to move JOB 6 and JOB 1 from the schedule queue to a waiting queue. In the embodiment, the waiting queue is a queue for storing the print jobs to which the print execution is not instructed.

The print jobs which are stored in the waiting queue are not printed until the print execution is instructed. All of the combining processes including a setting change of the print job are executed in the waiting queue. After completion of the combining processes, by returning the print jobs to the schedule queue, the present processing routine is finished.

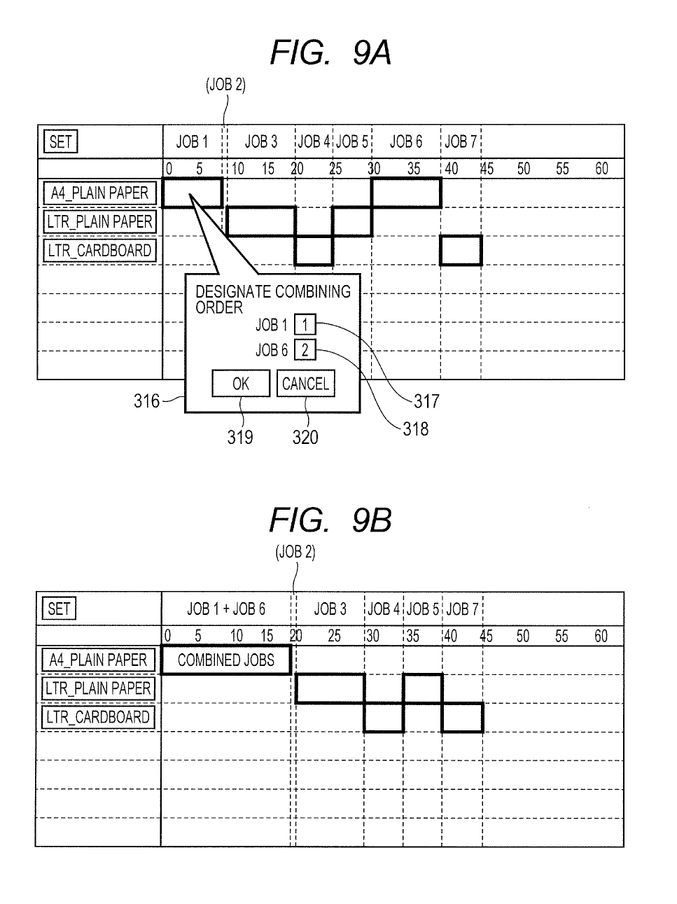

A print job management of the waiting queue is performed by waiting job management tables illustrated as examples in FIGS. 10A and 10B. Waiting numbers are allocated as identifiers to the print jobs which are managed in the waiting queue.

A waiting job management table 1001 after JOB 6 and JOB 1 were moved to the waiting queue is illustrated in FIG. 10A. Since the combining process of the print jobs is a well-known technique, its detailed description is omitted here. However, first of all, the combined print job is also stored into the waiting queue. In the example of the embodiment, JOB 6 and JOB 1 are combined. After the print jobs were combined, as illustrated in a waiting job management table 1002 as an example in FIG. 10B, the print job obtained by combining the two print jobs of JOB 1+JOB 6 is formed as waiting number 0003 in the waiting queue.

In the embodiment, an attribute showing the presence or absence of the combining and an attribute showing which print jobs were combined are held in the combined print job. Such attributes are held in order to decide into which print jobs the combined print job is divided when the operator wants to cancel the combining state of the combined print job.

Since a combination cancelling process of the print jobs is also a well-known technique, its detailed description is omitted here. After that, the generated print job is moved from the waiting queue to the schedule queue. However, a destination to which the print job is moved may be any one of a place where the print job of the combination destination has been stored and a place where the print job of the combining source has been stored. The storage destination of the combined print job is preliminarily stored in the RAM 113 as default storing position information. When the combined print job is returned to the schedule queue, the combined print job is stored in a predetermined position with reference to the storing position information.

For example, when the storing position information held in the RAM 113 indicates the place where the print job of the combination destination has been stored, a storage destination of the combined print job obtained by combining JOB 6 and JOB 1 indicates the place where JOB 1 has been stored. A schedule management table 502 after the combined print job was moved to the schedule queue is illustrated in FIG. 4B. By moving the combined print job to the schedule queue as mentioned above, the combining process is completed.

When the print job is returned to the schedule queue, if the execution of another print job such as JOB 2 or the like has been started, control is made in such a manner that the combined print job is moved to the schedule queue so that the combined print job is executed next to the job whose printing is being executed. After the combined print job was moved to the schedule queue, the processing routine is finished. As described above, the print jobs can be combined by the operator's drag & drop operation on the schedule screen.

### Process in the Case Where Print Job as Combining Target is Being Executed

Subsequently, a process which is executed in the case where the printing of the print job whose combination has been instructed by the operator is being executed will be described.

As an initial state, the print jobs which were input to the schedule queue are seven print jobs which are managed by the schedule management table 501 in FIG. 4A. It is assumed that on the basis of them, the screen shown in FIG. 3B is displayed on the operation panel 120.

It is also assumed that a setting to enlarge an area near the operator's operation when the job status bar having a difference of the numbers of prints of 100 or more approaches has been made on the screen enlargement process setting screen 901 illustrated in FIG. 6 by the operator. Further, it is assumed that the printing of the print job JOB 1 is being executed. At this time, a job execution state 503 in the schedule management table 501 illustrated in FIG. 4A is “being printed”.

Now, when the operator depresses the display area 307 to display the job status bar on the operation panel 120 in order to combine JOB 6 to JOB 1, in S601, the input processing unit 202 notifies the control processing unit 207 of it. After that, the processing routine advances to S610 in response to the operator's dragging operation on the operation panel 120. Since the processing contents have already been described in “operator's operation area enlargement and print job combining process by drag & drop”, their detailed description is omitted here. In S610, the control processing unit 207 accesses the RAM 113. The control processing unit 207 acquires the print information of the print job JOB 6 designated as a combining source when the operator has started the drag of the operation panel and the print information of the print job JOB 1 designated as a combination destination when the operator has removed the finger away from the operation panel. Further, the control processing unit 207 accesses the RAM 113 and discriminates whether or not JOB 1 or JOB 6 is being executed.

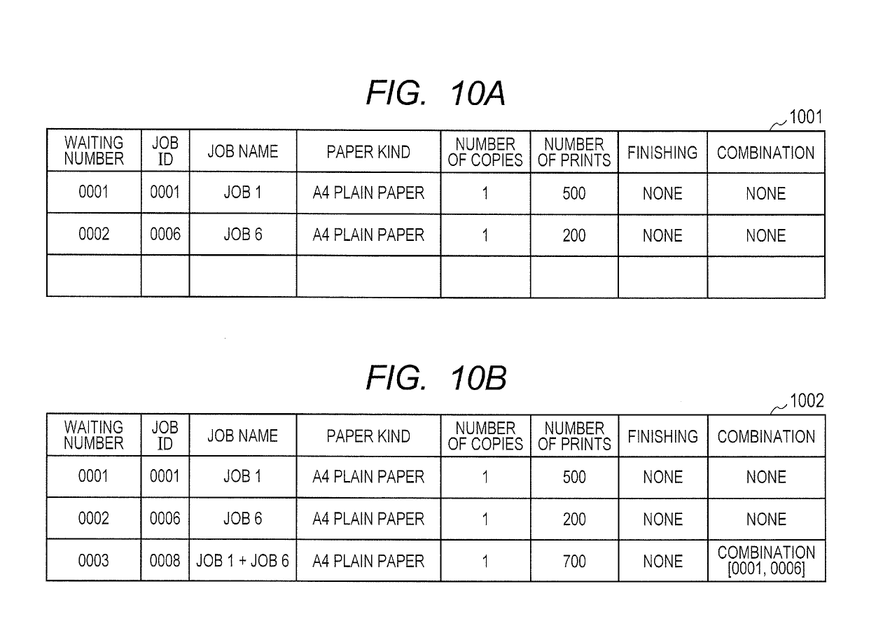

In the present case, the control processing unit 207 determines that JOB 1 is being executed, and advances the process to S612. In S612, the control processing unit 207 instructs the display processing unit 203 so as to display a screen 321 illustrated in FIG. 11 onto the operation panel 120. When the operator depresses a cancel button 323, the control processing unit 207 writes information showing that the cancel button 323 has been depressed into the RAM 113, and S612 follows.

When the operator depresses an OK button 322, the control processing unit 207 writes information showing that the OK button 322 has been depressed into the RAM 113, and S613 follows. In S613, the control processing unit 207 accesses the RAM 113 and reads out information showing which one of those buttons the operator depressed in S612.

If it is determined that the operator depressed the cancel button 323 in S612, the control processing unit 207 determines that the print job combining instruction is not performed, and advances the process to S601.

If it is determined that the operator depressed the OK button 322 in S612, the control processing unit 207 determines that the print job combining instruction has been performed, and advances the process to S614.

In S614, the control processing unit 207 instructs the printer engine 140 so as to stop JOB 1 being printed. After a print stop signal was received from the printer engine 140, the control processing unit 207 changes the job execution state 503 in the schedule management table 501 from “being printed” to “not executed”. The control processing unit 207 advances the process to S609.

After that, the processing routine advances in order of S609, S615, S611, S701, S704, S705, and S706. However, since they have already been described in detail in “operator's operation area enlargement and print job combining process by drag & drop”, their detailed description is omitted here.

In S706, the control processing unit 207 accesses the RAM 113 and moves JOB 6 and JOB 1 from the schedule queue to the waiting queue. The waiting job management table 1001 after JOB 6 and JOB 1 were moved to the waiting queue is as illustrated in FIG. 10A. A result obtained by combining the print jobs moved to the waiting queue becomes the waiting job management table 1002 illustrated in FIG. 10B. After that, the combined print job is moved to the schedule queue. After that, the control processing unit 207 instructs the printer engine 140 so as to start the execution of the combined print job, and finishes the process. As described above, even when the print job serving as a combining target is being executed, the print job being printed is stopped and the print job combining process can be executed.

### Combining Process of Print Jobs of a Plurality of Copies and the Same Number of Copies

Subsequently, a process in the case where the print jobs to which the combining instruction has been made by the operator correspond to a plurality of copies and the same number of copies will be described. Specifically speaking, a description will be made with respect to an example in which whether or not the number of output copies of the job of the moving source serving as a combining source and the number of output copies of the job of the movement destination serving as a combination destination are equal is discriminated, the operator is made to select whether or not the job executing order is changed, and the combining process is executed in accordance with a result of the selection.

As an initial state, it is assumed that the print jobs which were input to the schedule queue are seven print jobs which are managed by the schedule management table 501 in FIG. 4A and, on the basis of them, the schedule screen illustrated in FIG. 3B has been displayed on the operation panel 120. It is also assumed that such a setting that the area near the operator's operation is enlarged when the job status bar having the difference of the numbers of prints of 100 or more approaches has been made on the screen enlargement process setting screen 901 by the operator.

When the operator depresses a job status bar 324 on the operation panel 120 in order to combine JOB 5 to JOB 3, in S601, the input processing unit 202 notifies the control processing unit 207 of it. When the operator subsequently drags display areas 325 and 326 on the operation panel 120, the processing routine advances to S611. However, since the processing contents have already been described in “operator's operation area enlargement and print job combining process by drag & drop”, their detailed description is omitted here.

After that, the control processing unit 207 advances the process to S701. In S701, the control processing unit 207 accesses the RAM 113 and discriminates whether or not the numbers of prints of JOB 3 and JOB 5 to which the combining instruction has been made are equal to 2 or more. Since the numbers of prints of combining-instructed JOB 3 and JOB 5 are equal to 2, the control processing unit 207 advances the process to S702.

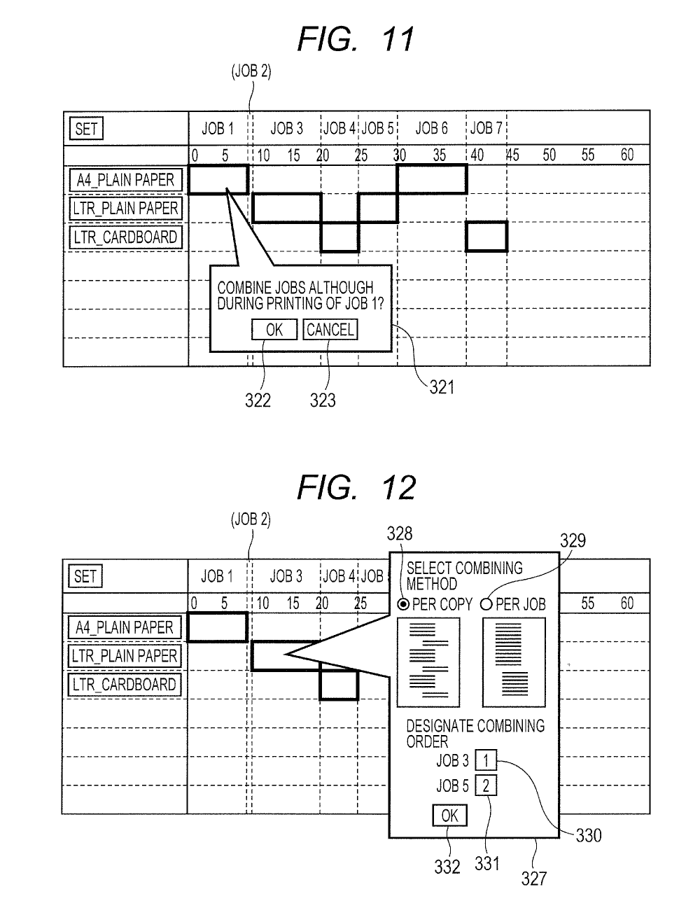

In S702, the control processing unit 207 accesses the RAM 113 and acquires a name of the print job serving as a combining target. Further, the control processing unit 207 instructs the display processing unit 203 so as to display a screen 327 illustrated in FIG. 12 onto the operation panel 120. After the control processing unit 207 displayed the screen 327 onto the operation panel 120, S703 follows. After that, the operator selects a radio button 328 or 329 and decides a combining method. When the operator selects the radio button 328, two print jobs are combined on a copy unit basis. When the operator selects the radio button 329, print jobs are combined on a print job unit basis. Since the combining method of the print jobs is a well-known technique, its detailed description is omitted here. After the combining method was selected, the operator inputs the combining order to input sections 330 and 331.

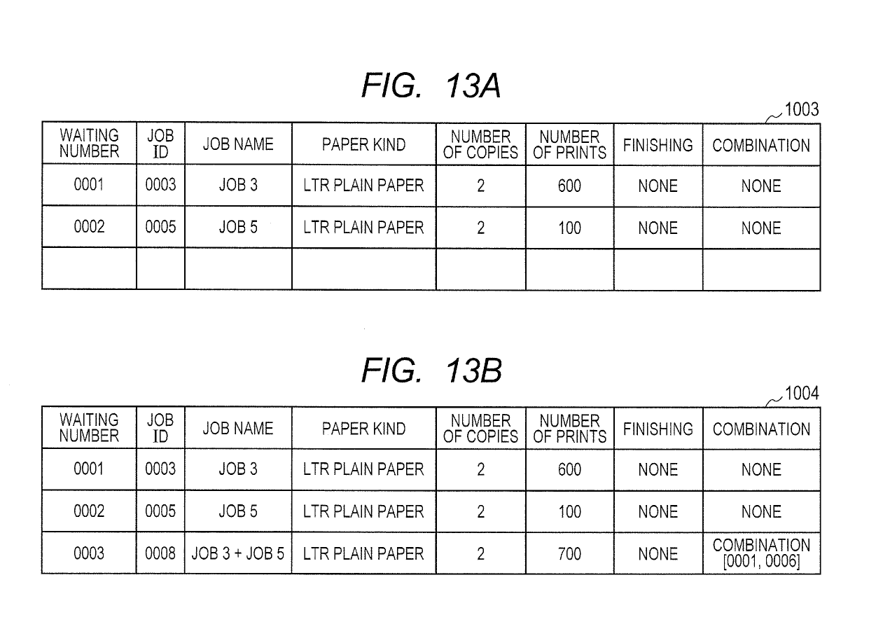

When the operator depresses an OK button 332, the control processing unit 207 accesses the RAM 113, writes the combining method and the combining order, and advances the process to S706. In S706, the control processing unit 207 accesses the RAM 113 and moves JOB 5 and JOB 3 from the schedule queue to the waiting queue. A waiting job management table 1003 after JOB 5 and JOB 3 were moved to the waiting queue is illustrated in FIG. 13A. In FIG. 13A, JOB 3 is managed by waiting number 0001 and JOB 5 is managed by waiting number 0002.

After that, the control processing unit 207 accesses the RAM 113 and acquires the combining method. In accordance with the acquired combining method, the control processing unit 207 combines JOB 5 and JOB 3. Since the combining process of the print jobs is a well-known technique, its detailed description is omitted here. The combined print job is stored as waiting number 0003 in the waiting queue.

A waiting job management table 1004 after JOB 5 and JOB 3 were combined is illustrated in FIG. 13B. After that, the control processing unit 207 moves the generated print job from the waiting queue to the schedule queue and finishes the process.

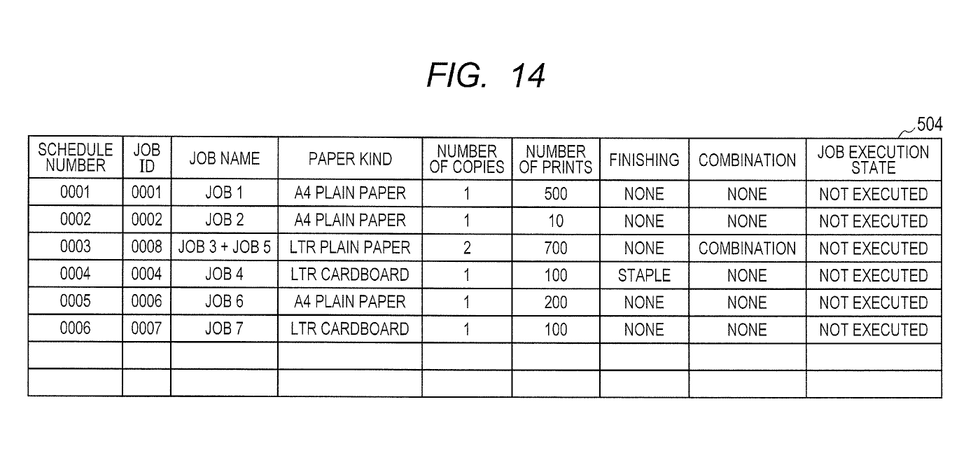

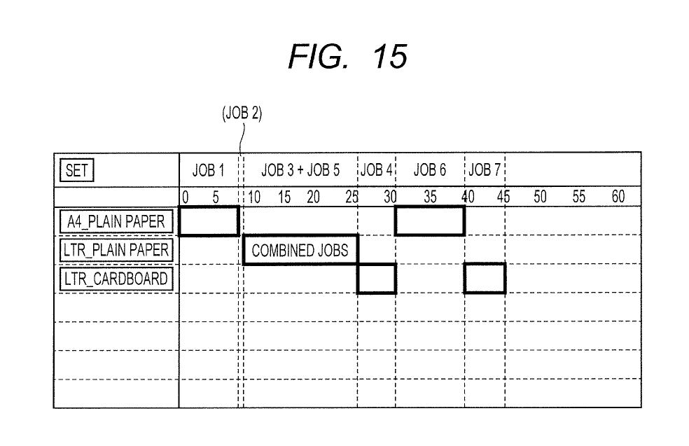

A schedule management table 504 after the combined print job was moved to the schedule queue is illustrated in FIG. 14. A screen of the operation panel 120 after the jobs were combined is illustrated in FIG. 15. As described above, when the print jobs serving as combining targets are the print jobs corresponding to a plurality of copies and the same number of copies, the operator is made to select the combining method and the combining process of the print jobs can be executed.

### Combining Process of Print Jobs Having Different Print Attributes

Subsequently, a process in the case where the print jobs to which the combining instruction was made by the operator have different print attributes will be described.

As an initial state, it is assumed that the print jobs which were input to the schedule queue are the seven print jobs which are managed by the schedule management table 501 in FIG. 4A and, on the basis of them, the schedule screen illustrated in FIG. 3B has been displayed on the operation panel 120.

It is also assumed that such a setting that the area near the operator's operation is enlarged when the job status bar having the difference of the numbers of prints of 100 or more approaches has been made on the screen enlargement process setting screen 901 by the operator. When the operator depresses a job status bar 333 on the operation panel 120 in order to combine JOB 7 to JOB 4, in S601, the input processing unit 202 notifies the control processing unit 207 of it.

When the operator subsequently drags display areas 334, 335, and 336 on the operation panel 120, the processing routine advances to S615. Since the processing contents have already been described in “operator's operation area enlargement and print job combining process by drag & drop”, their detailed description is omitted here.

In S615, the control processing unit 207 instructs the print attribute difference determination unit 205 so as to discriminate whether or not the print attributes acquired in S609 coincide. Since the finishing settings in the print attributes of JOB 7 and JOB 4 differ, the control processing unit 207 advances the process to S616. The process in S616 will be described in detail from S801.

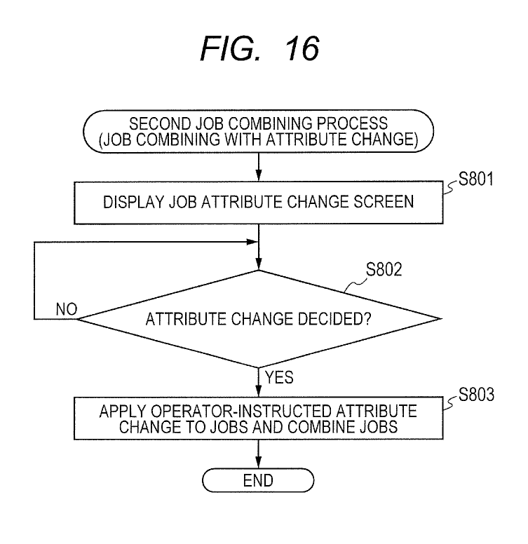

FIG. 16 is a flowchart for describing the control method of the job processing apparatus showing the embodiment. This flowchart relates to an example of the detailed process of the second job combining process shown in S616 in FIG. 5B. Each processing step is realized by a method whereby the CPU 114 in the controller box 200 executes each process in accordance with the program stored in the HDD 115. A description will be made with respect to a process for changing the attributes when the attributes do not coincide in the case of receiving such an operation that the operator drags a bar of the moving source of the job displayed on the schedule screen and drops to a bar of the movement destination.

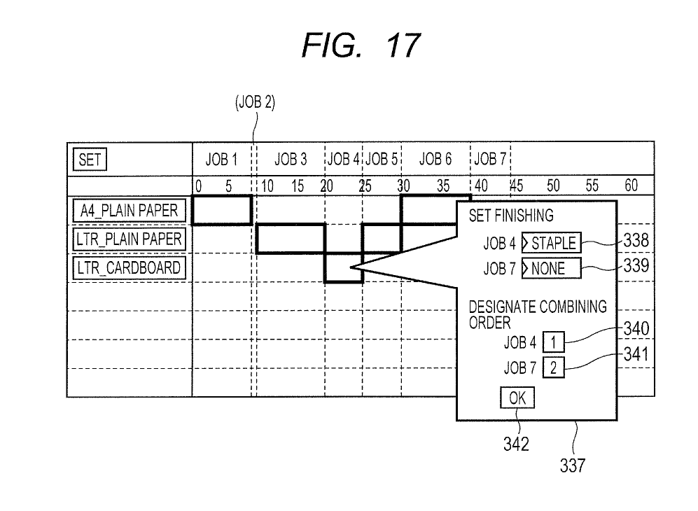

In S801, the control processing unit 207 accesses the RAM 113 and acquires the print attribute information of JOB 7 and JOB 4. Finishing candidates which are supported by the printer engine 140 are also acquired from the RAM 113. After that, the control processing unit 207 instructs the display processing unit 203 so as to display a screen 337 illustrated in FIG. 17 onto the operation panel 120. After that, S802 follows.

Subsequently, the operator operates the operation panel 120, selects a finishing setting of JOB 4 by a selection section 338, and selects a finishing setting of JOB 7 by a selection section 339. The operator designates combining order by selection sections 340 and 341. After those operations were executed, the operator depresses an OK button 342.

After the foregoing setting by the operator was finished, the control processing unit 207 instructs the input processing unit 202 so as to acquire finishing information of the finishing setting selected by the operator and information regarding the combining order, and stores those information into the RAM 113.

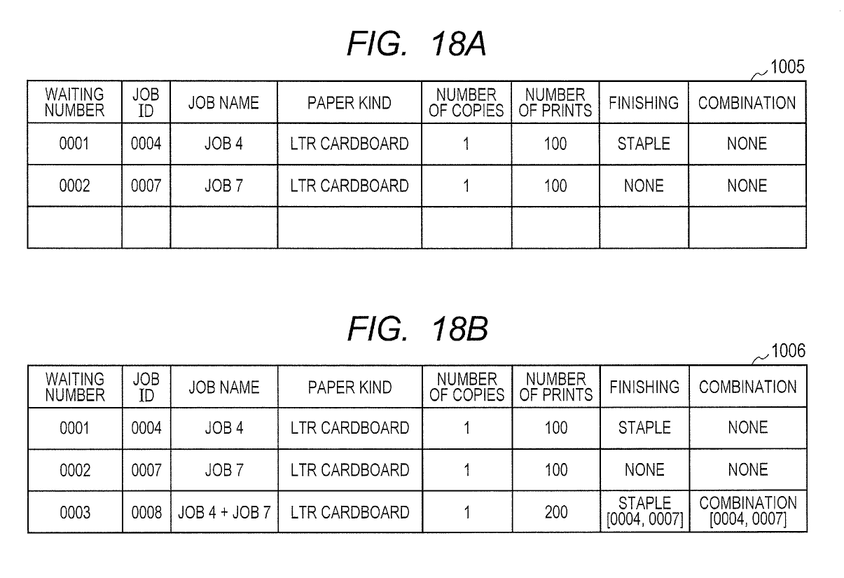

In S802, the control processing unit 207 accesses the RAM 113 and discriminates whether or not the finishing setting and the combining order setting have been made by the operator. If the control processing unit 207 determined that the finishing setting and the combining order setting have been made by the operator, S803 follows. In S803, the control processing unit 207 accesses the RAM 113 and moves JOB 7 and JOB 4 from the schedule queue to the waiting queue. A waiting job management table 1005 after JOB 7 and JOB 4 were moved to the waiting queue is illustrated in FIG. 18A. JOB 4 is managed as waiting number 0001 and JOB 7 is managed as waiting number 0002.

Since the combining process of the print jobs is a well-known technique, its detailed description is omitted here. The combined print job is stored as waiting number 0003 into the waiting queue.

As illustrated in a job waiting table 1006 in FIG. 18B, a print job obtained by combining the two print jobs of JOB 4+JOB 7 is generated as waiting number 0003. In addition to an attribute about the presence or absence of the combining, an attribute showing to which print job the finishing setting has been made are held in the combined print job.

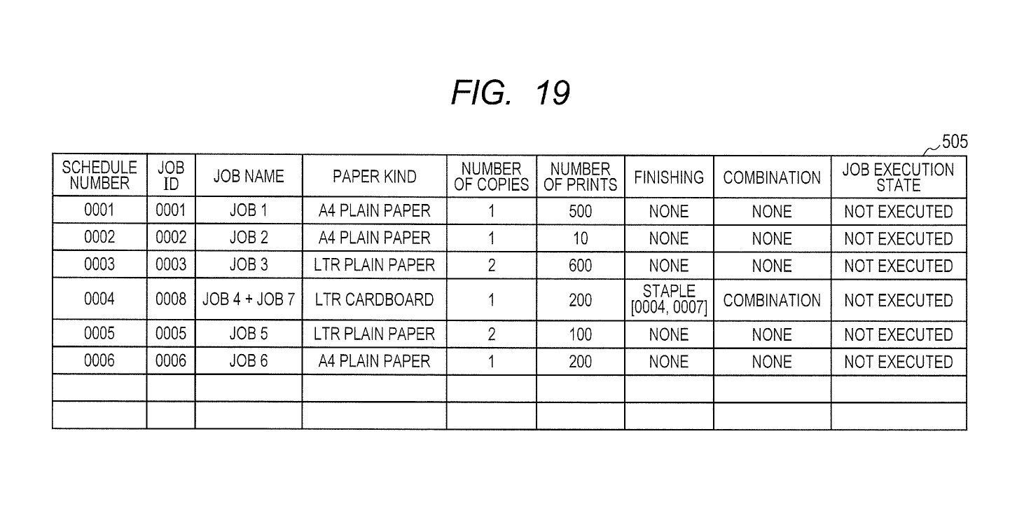

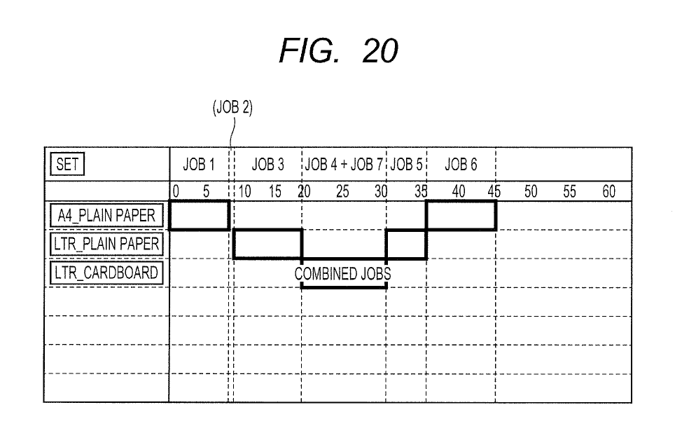

After that, the generated print job is moved from the waiting queue to the schedule queue and the process is finished. A schedule management table 505 after the combined print job was moved to the schedule queue is illustrated in FIG. 19. A screen of the operation panel 120 after the jobs were combined is illustrated in FIG. 20. As described above, when the print attributes of the print jobs serving as combining targets differ, the operator is made to select the print attributes and the combining process of the print jobs can be executed.

Although the embodiment has been described with respect to such a process that each job is combined by the operator's drag & drop process among the displayed jobs, control can be also combined so as to divide the combined job.

Each processing step of the invention can be also realized by a method whereby a processing apparatus (CPU, processor) such as a personal computer (computer) or the like executes software (program) obtained through a network or various kinds of storage media.

The invention is not limited to the foregoing embodiments but various modifications (including an organic combination of the embodiments) are possible based on the spirit of the invention and they should not be excluded from the scope of the invention.

According to the invention, the displayed jobs can be combined by a simple operation instruction to the schedule screen of the jobs which are displayed.

### Other Embodiments

Embodiments of the present invention can also be realized by a computer of a system or apparatus that reads out and executes computer-executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer-executable instructions from the storage medium to perform the functions of one or more of the above-described embodiment(s). The computer may comprise one or more of a central processing unit (CPU), micro processing unit (MFU), or other circuitry, and may include a network of separate computers or separate computer processors. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-131636, filed Jun. 24, 2013, which is hereby incorporated by reference herein in its entirety.

What is claimed is:

1. A job processing apparatus comprising:
a display unit configured to display a schedule screen of jobs to be executed;
a receiving unit configured to receive an operation for moving a display object of a first job displayed on the schedule screen to a display object of a second job; and
a combining unit configured to combine the first job and the second job in accordance with the operation received by the receiving unit.

2. An apparatus according to claim 1, further comprising an updating unit configured to update the schedule screen displayed on the display unit on the basis of information of the jobs combined by the combining unit.

3. An apparatus according to claim 1, further comprising:
a determining unit configured to determine whether or not an attribute of the first job and an attribute of the second job coincide when the operation is received by the receiving unit; and
an attribute changing unit configured to change the attribute of the first job or the second job in response to an instruction to change the attribute of the job if it is determined by the determining unit that the attribute of the first job and the attribute of the second job do not coincide.

4. An apparatus according to claim 1, further comprising:
a judging unit configured to judge whether or not a difference between the number of output prints of the first job and the number of output prints of the second job exceeds a predetermined value when the operation is received by the receiving unit; and
a display control unit configured to enlarge and display an area exceeding the predetermined value if it is determined by the judging unit that the difference between the number of output prints of the first job and the number of output prints of the second job exceeds the predetermined value.

5. An apparatus according to claim 1, further comprising:
a detecting unit configured to detect that the number of output copies of the first job and the number of output copies of the second job are equal when the operation is received by the receiving unit; and
an order changing unit configured to change executing order of the first job and the second job if it is detected by the detecting unit that the number of output copies of the first job and the number of output copies of the second job are equal.

6. An apparatus according to claim 1, wherein on the schedule screen, a kind of paper is displayed on an axis of ordinate and a time is displayed on an axis of abscissa.

7. An apparatus according to claim 1, wherein the operation is a dragging operation.

8. A display control method of a job processing apparatus having a display unit configured to display a schedule screen of jobs to be executed, comprising:
receiving an operation for moving a display object of a first job displayed on the schedule screen to a display object of a second job; and
combining the first job and the second job in accordance with the operation received by the receiving step.

9. A non-transitory computer-readable storage medium storing a program to cause a computer to execute a display control method of a job processing apparatus having a display unit configured to display a schedule screen of jobs to be executed, wherein the program comprises:
a code for receiving an operation for moving a display object of a first job displayed on the schedule screen to a display object of a second job; and
a code for combining the first job and the second job in accordance with the operation received by the receiving code.
